(19) United States
(12) Patent Application Publication
(10) Pub. No.: US 2026/0368235 A1
(43) Pub. Date: Nov. 19, 2026

(54) SYSTEMS AND METHODS FOR AUTOMATED DIGITAL CONTENT CURATION AND DISTRIBUTION

(71) Applicant: Simon Galperin, Bloomfield, NJ (US)

(72) Inventor: Simon Galperin, Bloomfield, NJ (US)

(21) Appl. No.: 19/677,923

(22) Filed: May 14, 2026

Related U.S. Application Data
(60) Provisional application No. 63/805,744, filed on May 14, 2025.

(51) Int. Cl. G06F 16/34; G06F 16/35; G06F 16/955

(52) U.S. Cl. CPC G06F 16/345; G06F 16/35; G06F 16/955

(57) ABSTRACT

The disclosed technology relates to methods, curation systems, and non-transitory computer readable media for automated digital content curation and distribution. In some examples, unstructured digital content and associated metadata is ingested to a record of a database. The unstructured digital content is obtained via a harvesting application executed by an editor device. A stored and trained machine learning model is applied to the unstructured digital content and the metadata to generate and store in the record structured contextual data comprising a summary and a headline for news items and a title for event items. The record is linked to a newsletter in the database based on a geographic region determined via parsing the unstructured digital content or the metadata. Upon satisfaction of staging criteria, the newsletter is published via a webpage hosted by a web server based on contents of the record.

This application claims priority to U.S. Provisional Patent Application Ser. No. 63/805,744, filed May 14, 2025, which is hereby incorporated herein by reference in its entirety.

### FIELD

This technology generally relates to orchestration of digital content distribution and, more particularly, to methods and systems for efficient, automated digital content curation and distribution across multiple digital platforms.

### BACKGROUND

The volume of hyper-local content like community news, school district updates, or municipal event calendars is vast but scattered across disparate platforms and data systems. National news publishers benefit from standardized Really Simple Syndication (RSS) feeds and Application Programming Interfaces (APIs) as sources of information, but hyper-local, community-level data resides in unstructured formats on social media pages, proprietary municipal websites, and isolated community bulletins, for example.

This fragmentation creates significant technical hurdles for local news providers building aggregation systems, which must ingest unstructured data from these diverse sources and normalize it into a structured schema suitable for distribution. Existing systems lack the architecture to maintain data integrity while simultaneously orchestrating the transformation of this unstructured input into multi-format outputs required for synchronous publication across web, email, and social media channels.

Existing systems also face latency and scalability challenges when attempting to personalize or categorize content for specific local geographic regions or user interests at scale. Traditional methods of content curation fail to handle the computational complexity of deduplicating conflicting event data, resolving version control issues between draft and published states, and dynamically formatting content to meet the requirements of third-party destination platforms. Current architectures are simply incapable of automating the ingestion, semantic analysis, and structured distribution of digital content to ensure consistent, accurate, and timely dissemination across a heterogeneous network environment.

### SUMMARY

The disclosed technology relates to computer-implemented systems and methods for automated ingestion, classification, processing, deduplication, and distribution of digital content from multiple data sources. In some examples, one or more computing devices of a curation system receive unstructured content from a plurality of sources and perform an automated classification to determine the content type, including, for example, distinguishing between news content and event-related content. Based on this classification, the system will selectively apply one or more processing workflows associated with the determined content type.

In some examples, the curation system generates structured data from the received content, including generating summaries, extracting or generating headlines, assigning categories, and formatting content for downstream use. The curation system may incorporate automated processing techniques and, in some cases, user input to refine or validate the processed content. The curation system may further perform automated orchestration of downstream workflows, including compiling content, applying stylistic and technical adjustments, and publishing content across multiple output channels, including websites, newsletters, and social media platforms.

The disclosed technology advantageously improves the operation of computer systems by enabling efficient processing of unstructured content, reducing redundant data processing through automated deduplication, and facilitating scalable, multi-platform distribution of content.

Methods, curation systems, and non-transitory computer readable media for automated digital content curation and distribution that, in some examples, ingest, to a record of a database of the curation system, unstructured digital content and associated metadata from an editor device via one or more communication networks. The unstructured digital content is hosted by a content source device coupled to the communication networks and is obtained via a harvesting application that is executed by the editor device and is communicably coupled to the database. A determination is made as to whether the unstructured digital content corresponds to a news item or an event item based on an analysis of the unstructured digital content or the metadata to determine whether a date is identified therein. The metadata is obtained via a graphical user interface generated and output to the editor device by the harvesting application.

A stored and trained machine learning model is applied to the unstructured digital content and the metadata to generate and store in the record structured contextual data comprising a summary and a headline, when the determination indicates the unstructured digital content corresponds to the news item, and a title, when the determination indicates the unstructured digital content corresponds to the event item, after determining via polling of the database by an automated orchestration application that the record was created.

The record is linked to a newsletter in the database based at least in part on a geographic region determined via parsing, by the automated orchestration application, one or more of the unstructured digital content or the metadata. The record is linked to the newsletter in the database based on a generated unique identifier for the newsletter. Upon satisfaction of staging criteria, the newsletter is published via a first webpage hosted by a web server of the curation system based on contents of the record, wherein the published newsletter comprises the date and the title or the news headline and the summary.

In some examples, one or more artificial intelligence assistants within the automated orchestration application are applied to at least one of the unstructured digital content or the metadata to perform one or more of duplicate item checking, event title writing, news article headline writing, or news article summarization. In other examples, a featured image for the event item is obtained using a uniform resource locator in the metadata for a webpage associated with the unstructured digital content. The featured image is stored in the record. The featured image for the event item is then published from the record via a second webpage hosted by the web server and hyperlinked to one or more of the date or the title.

Post characteristics comprising one or more of a headline length, a font code, a color template, or a date format can be generated in some examples. Based on the post characteristics and one or more of the unstructured digital content or the metadata, a snippet comprising webpage source code can also be generated. In these examples, a social media post comprising an image generated based on a rendering of the snippet according to the webpage source code can be published via an application programming interface for a social media platform.

In yet other examples, an item initial review interface comprising at least a portion of the unstructured digital content or the metadata and editable fields for a body and the headline or the title is generated and provided to the editor device. The body is generated from the unstructured digital content by an artificial intelligence assistant within the automated orchestration application. A newsletter orchestration interface comprising newsletter context data generated from the database based on the unique identifier for the newsletter can also be generated and provided to the editor device. The staging criteria can be obtained, and stored in the database, via the newsletter orchestration interface. The staging criteria comprises at least a timing of distribution of the newsletter.

### BRIEF DESCRIPTION OF THE DRAWINGS

The disclosed technology is illustrated by way of example and not limitation in the accompanying figures, in which like references indicate similar elements:

FIG. 1 is a block diagram of an exemplary network environment that includes a curation system;

FIG. 2 is a block diagram of an exemplary curation system;

FIG. 3 is a flow diagram of another exemplary method for automated digital content curation and distribution;

FIG. 4 is a flowchart of an exemplary method for automated digital content curation and distribution;

FIG. 5 is a screenshot of an exemplary harvesting tool content ingestion interface;

FIG. 6 is a screenshot of an exemplary harvesting tool metadata ingestion interface;

FIG. 7 is a flowchart of an exemplary method for event and news item database population;

FIG. 8 is a screenshot of an AI assistant dashboard;

FIG. 9 is a screenshot of a content item database interface from the perspective of news items;

FIG. 10 is a screenshot of a portion of a content item database interface from the perspective of a newsletter;

FIG. 11 is a screenshot of an exemplary item initial review interface;

FIG. 12 is a screenshot of an exemplary item final review interface;

FIGS. 13A-B are flowcharts of an exemplary method for event item database population;

FIGS. 14A-B are flowcharts of an exemplary method for third-party social media newsletter publication;

FIG. 15 is a screenshot of an exemplary event publication.

FIG. 16 is a screenshot of an exemplary newsletter final review interface;

FIG. 17 is a screenshot of an exemplary newsletter orchestration interface; and

FIG. 18 is a screenshot of an exemplary newsletter publication.

### DETAILED DESCRIPTION

The technology described and illustrated herein provides an efficient curation system 102 capable of gathering, processing, and distribute large numbers of news briefs and events across multiple digital platforms (e.g., web, e-mail, and social media). In one exemplary implementation, a combination of Airtable™, Zapier™, artificial intelligence (AI) chatbot assistants (e.g., ChatGPT™ available from OpenAI), WordPress™, and/or Mailchimp™ applications are used to regularly curate or “harvest” many (e.g., thousands) of news items, event items, and/or other pieces of digital content (e.g., community information) from multiple sources to produce and publish a series of daily local newsletters, event calendars, websites, and/or social media content (e.g., Instagram™ posts).

This technology facilitates automated review and management of a large number of relevant news sources that are automatically summarized into news reports as well as publication/dissemination of the local news reports and events (e.g., to various geographic regions). Thus, the technology is an automated curation system 102 that collects relevant and newsworthy data from various feeds (e.g., school district websites, local/state publishers, Facebook™ groups, etc.) using a cloud-based relational database platform (e.g., a custom Airtable and associated web clipper extension) that serves as the center for content management. The disclosed curation system 102 includes automated features that identify geographic region(s) and subject(s) to which news items should be distributed and categorized and advantageously uses generative AI to summarize draft news reports and events from their sources to facilitate efficient newsletter publication for those news items.

Accordingly, this technology provides a number of advantages including methods, non-transitory computer readable media, and curation systems that facilitate improved and more efficient digital content curation, generation, orchestration, and publication. The disclosed technology is scalable, efficient with respect to summarizing, formatting, and distributing digital content, consistent as it maintains a standardized process across multiple platforms and communities, and flexible by easily adapting to add new communities or content types, for example.

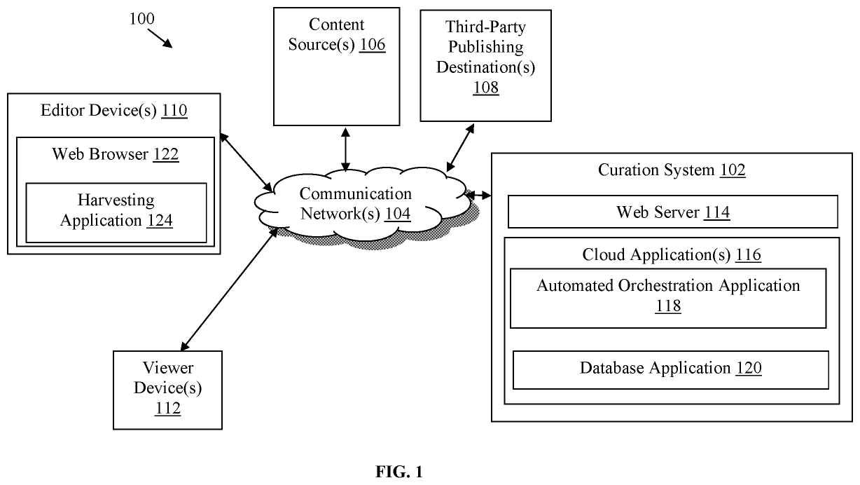

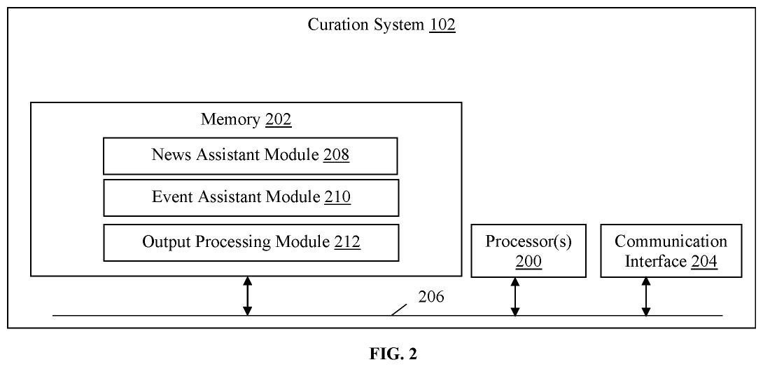

Referring to FIG. 1, an exemplary network environment 100 is illustrated that includes the curation system 102 coupled via communication network(s) 104 to content source(s) 106, third-party publishing destination(s) 108, editor device(s) 110, and view device(s) 112. The network environment 100 may include other network devices such as one or more routers, switches, firewall devices, and/or mid-servers, for example, which are known in the art and thus will not be described herein.

In this particular example, the curation system 102 includes an optional web server 114 for hosting published digital content (e.g., newsletters) accessible to end users of the viewer device(s) 112 and cloud applications 116, which include an automated orchestration application 118 or platform (e.g., as provided Zapier) and a database application (e.g., a cloud relational database system provided by Airtable), although other cloud applications can also be used in other examples. Additionally, the editor device(s) 110 include a web browser 122 and a harvesting application 124 (e.g., a web clipper provided by Airtable), which can be a plug-in coupled to the web browser and communicably linked to the database application 120. The operation of these various devices and components will be described and illustration in detail below.

In one example, the curation system 102 includes one or more computing devices. Thus, the web server 114 and/or any number of the cloud applications 116 may be distributed across any number of computing devices of the curation system 102 communicably coupled via the communication network(s) 104. Additionally, while the curation system 102, content source(s) 106, third-party publishing destination(s) 108, editor device(s) 110 and viewer device(s) 112 are disclosed in FIG. 1 as dedicated hardware devices, one or more of the curation system 102, content source(s) 106, third-party publishing destination(s) 108, editor device(s) 110 and/or viewer device(s) 112 can also be implemented in software within one or more other devices in the network environment 100.

Referring now to FIGS. 1-2, the curation system 102 of the network environment 100 may perform any number of functions as described and illustrated by way of the examples herein, including interfaces with the editor device and the cloud application(s) 116 to publish generated newsletters and other digital content resulting from curation of news and event items hosted by the content source(s) 106, for example. The curation system 102 in this example includes processor(s) 200, a memory 202, and a communication interface 204, which are coupled together by a bus 206, although the curation system 102 can include other types or numbers of elements in other configurations.

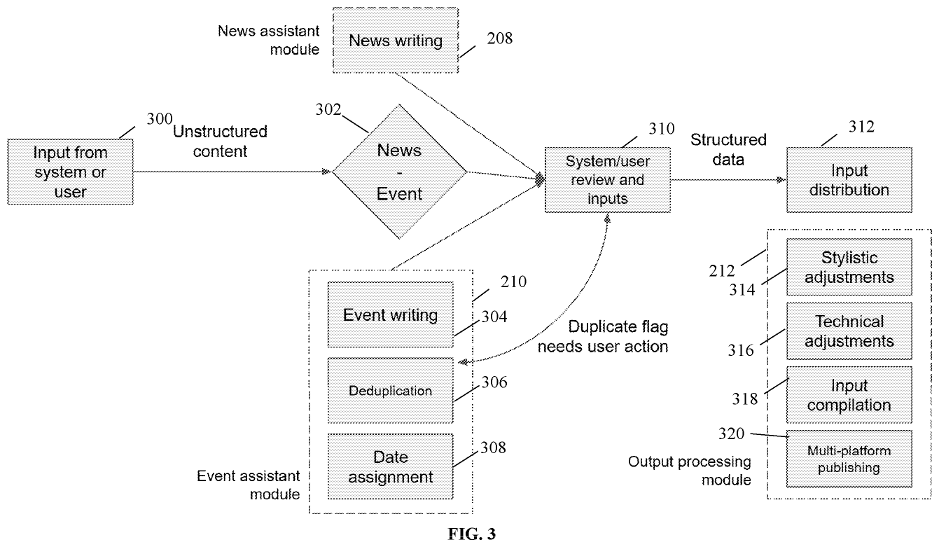

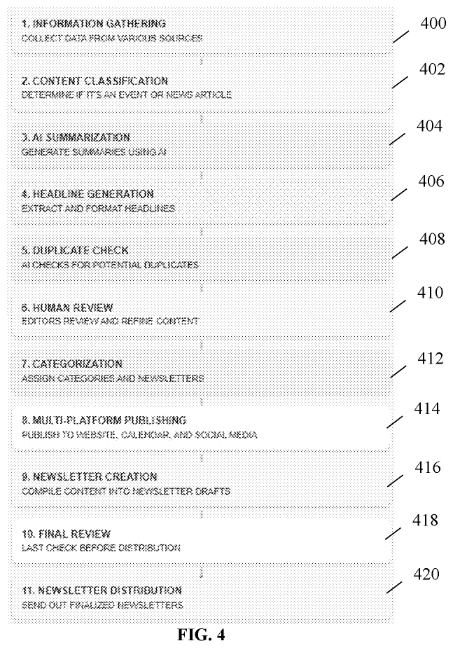

The processor(s) 200 of the curation system 102 may execute programmed instructions stored in the memory 202 of the curation system 102 for any number of the functions described and illustrated herein (e.g., with reference to FIGS. 3-18). The processor(s) 200 may include one or more central processing units or with one or more processing cores, for example, although other types of processor(s) can also be used.

The memory 202 of the curation system 102 stores these instructions for one or more aspects of the present technology as described and illustrated herein, although some or all of the instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for the memory 202.

Accordingly, the memory 202 can store one or more applications that can include computer executable instructions that, when executed by the curation system 102, cause the curation system 102 to perform actions, such as to transmit, receive, or otherwise process network messages and requests, for example, and to perform other actions described and illustrated below with reference to FIGS. 3-18. The application(s) can be implemented as components of other applications, operating system extensions, and/or plugins, for example.

Further, the application(s) may be operative in a cloud-based computing environment. The application(s) can be executed within or as virtual machine(s) or virtual server(s) that may be managed in a cloud-based computing environment. Also, the application(s), and even the curation system 102 itself, may be located in virtual server(s) running in a cloud-based computing environment rather than being tied to one or more specific physical network computing devices. The application(s) may be running in one or more virtual machines (VMs) executing on the curation system 102. Additionally, in one or more examples of this technology, virtual machine(s) running on the curation system may be managed or supervised by a hypervisor.

In this particular example, the memory 202 includes a news assistant module 208, an event assistant module 210, and an output processing module 212. The news assistant module 208 is configured to facilitate news item publishing from harvested digital content by leveraging AI to generate content and metadata that can be efficiently reviewed, approved, and orchestrated for publishing. The event assistant module 210 is configured to perform similar tasks for events (i.e., harvested digital content having an associated date). In addition, the event assistant module 210 is configured to perform deduplication to ensure multiple entries are not published to a calendar for the same event, for example. The event assistant module 210 is also configured to assign the event item to a date for publishing, which can be based on the date of occurrence of the event as harvested.

The output processing module 212 in this example is configured to apply templates and other automated analysis to reviewed digital content (e.g., news items) to facilitate automated publishing (e.g., via the web server 114 and/or third-party publishing destination(s) 108) in a desired format. The operation of the news assistant module 208, an event assistant module 210, and an output processing module 212 is described and illustrated in more detail below with reference to FIGS. 3-18.

The communication interface 204 of the curation system 102 operatively couples and communicates between the curation system 102 and the cloud application(s), content source(s) 106, third-party publishing destination(s) 108, editor device(s) 110, and viewer device(s) 112, which are coupled together at least in part by the communication network(s) 104 (e.g., a wide area network (WAN)), although other types or another number of communication networks or systems with other types or numbers of connections or configurations to other devices or elements can also be used. By way of example only, the communication network(s) 104 can use TCP/IP over Ethernet and industry-standard protocols, although other types or numbers of protocols or communication networks can be used. The communication network(s) can include the Internet and can employ any suitable interface mechanisms and network communication technologies including, for example, Ethernet-based Packet Data Networks (PDNs).

While the curation system 102 is illustrated in this example as including a single device, the curation system 102 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the curation system 102. Additionally, one or more of the devices that together comprise the curation system 102 in other examples can be standalone devices or integrated with one or more other devices or apparatuses.

The cloud application(s) 116 of the curation system 102 can be hosted by any number of computing and/or server devices of the curation system 102 and can provide integrations (e.g., via application programming interfaces (APIs)) for facilitating aspects of the methods described and illustrated by way of the examples herein. For example, the cloud application(s) 116 can be hosted by and/or associated with one or more of Airtable, Zapier, ChatGPT Assistants via the OpenAI API, WordPress, and/or Mailchimp applications, for example. Accordingly, the cloud application(s) 116 can be hosted by computing device(s) that each include a processor, a memory, and a communication interface, which are coupled together by a bus or other communication link (not illustrated), although other numbers or types of components could also be used

The content source(s) 106 can be servers or other computing devices hosting digital content, such as digital news reports or articles, event calendars, or any other digital information, for example. The content source(s) 106 can be databases, web servers hosting web pages with the digital content, or any other type of data storage device. Thus, the content source(s) 106 include a processor, a memory, and a communication interface that are coupled together by a bus or other communication link (not illustrated), although other numbers or types of components could also be used.

Each of the editor device(s) 110 of the network environment 100 in this example includes any type of computing device that can exchange network data, such as mobile, desktop, laptop, or tablet computing devices, virtual machines (including cloud-based computers), or the like. Each of the editor device(s) 110 includes a processor, a memory, and a communication interface, which are coupled together by a bus or other communication link (not illustrated), although other numbers or types of components could also be used.

Each of the editor device(s) 110 may run interface applications, such as the web browser 122 or standalone client applications, which may provide an interface to communicate with the curation system 102 and/or the content source(s) 106 via the communication network(s) 104. More specifically, users of the editor device(s) 110 may view content (e.g., web page news items) retrieved from the content source(s) 106 and execute the harvesting application 124 to ingest portions of the content and metadata associated with the content for transmission to the curation system 102 (e.g., the database application 120) and subsequent publishing.

Other users of the editor device(s) 110 can use the web browser 122 to interface with graphical user interfaces (GUIs) or dashboards provided by the curation system 102 (e.g., the database application 120) to annotate the database records associated with the content and facilitate automated publication by the automated orchestration application 118. Accordingly, each of the editor device(s) 110 may further include a display device, such as a display screen or touchscreen, or an input device, such as a keyboard or mouse, for example (not illustrated).

The third-party publishing destination(s) 108 of the network environment 100 can be hosted by any number of computing and/or server devices and can also provide integrations (e.g., via APIs) to the curation system 102 for facilitating publishing or newsletters and other digital content generated by the curation system 102. For example, the third-party publishing destination(s) 108 can be server(s) hosted by social media networks in some examples. Accordingly, the third-party publishing destination(s) 108 can include computing device(s) that each includes a processor, a memory, and a communication interface, which are coupled together by a bus or other communication link (not illustrated), although other numbers or types of components could also be used.

Each of the viewer device(s) 112 of the network environment 100 in this example includes any type of computing device that can exchange network data, such as mobile, desktop, laptop, or tablet computing devices, virtual machines (including cloud-based computers), or the like. Each of the viewer device(s) 112 includes a processor, a memory, and a communication interface, which are coupled together by a bus or other communication link (not illustrated), although other numbers or types of components could also be used.

Each of the viewer device(s) 112 may run interface applications, such as standard web browsers or standalone client applications, which may provide an interface to communicate with the third-party publishing destination(s) 108 via the communication network(s) 104 to view and interface with digital content generated and/or published by the curation system 102, for example. Each of the viewer device(s) 112 may further include a display device, such as a display screen or touchscreen, or an input device, such as a keyboard or mouse, for example (not illustrated).

Although the exemplary network environment 100 with the curation system 102, content source(s) 106, third-party publishing destination(s) 108, editor device(s) 110, viewer device(s) 112, and communication network(s) 104 are described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the network environment 100, such as the curation system 102, content source(s) 106, third-party publishing destination(s) 108, editor device(s) 110, or viewer device(s) 112, for example, may be configured to operate as virtual instances on the same physical machine. In other words, one or more of the curation system 102, content source(s) 106, third-party publishing destination(s) 108, editor device(s) 110, or viewer device(s) 112 may operate on the same physical device rather than as separate devices communicating through the communication network(s) 104. Additionally, there may be more or fewer data curation systems, content source(s), third-party publishing destination(s), editor device(s), or viewer device(s) than illustrated in FIG. 1.

The examples of this technology may also be embodied as one or more non-transitory computer readable media having instructions stored thereon, such as in the memory 202 of the curation system 102, for one or more aspects of the present technology, as described and illustrated by way of the examples herein. The instructions in some examples include executable code that, when executed by one or more processors, such as the processor(s) 200 of the curation system 102, cause the processors 200 to carry out steps necessary to implement the methods of the examples of this technology that are described and illustrated herein.

Referring to FIG. 3, a flow diagram of another exemplary method for automated digital content curation and distribution is illustrated. In step 300 in this example, unstructured content is harvested or ingested by the curation system 102 (e.g., from the content source(s) 106 and by a user of the editor device(s) 110), which can include news or events, for example. In step 302, the curation system 102 determines whether the ingested content is a news item or an event item. The determination in step 302 can be determined based on a manual input of type metadata from the user of the editor device(s) 110 or based on a search of the content for a date that would indicate the content is an event item.

Based on the determination in step 302, the news assistant module 208 or the event assistant module 210 of the curation system 102 generates automated digital content configured for distribution, which can include generating headlines and/or summaries, for example, optionally in an automated manner using AI chat assistants. With respect to the event assistant module 210 in one example, the curation system 102 can write the event in step 304, perform deduplication in step 306 to determine whether the event has already been received, processed, stored, published, and/or scheduled for publishing, and, in step 308, schedule the event for publishing by assigning a date to the event corresponding to the event date or deadline, for example.

The written news item or event item is then manually or automatically reviewed, finalized, and/or approved for publishing via GUIs provided to the editor device(s) 110. The review can include editing of AI-generated headlines or other metadata associated with the news or event item. The result of the review and approval is structured data maintained by the database application 120. The structured data is then prepared by the curation system 102 (e.g., the automated orchestration application 118) for distribution in step 310. In particular, the output processing module 212 in this example can automatically introduce stylistic adjustments in step 312.

In step 312, the curation system 102 performs input distribution by routing the structured data to one or more downstream processing components, including an output processing module 212 that is configured to prepare the content for its publication on various platforms. The output processing module 212 may then perform one or more operations to transform the structured data for distribution.

In step 314, the output processing module 212 may apply stylistic adjustments to the content, including modifying formatting, tone, or presentation attributes to conform to the specific platform's requirements. 62. In step 316, the output processing module 212 may apply technical adjustments to the content to ensure compatibility with downstream systems. In step 318, the output processing module 212 may combine one or more inputs (e.g., other structured data) associated with the content into a unified representation that is suitable for distribution. In step 320, the output processing module 212 may initiate multi-platform publishing (e.g., via APIs provided by the third-party publication destination(s) 108) by transmitting the compiled content to one or more external systems or platforms.

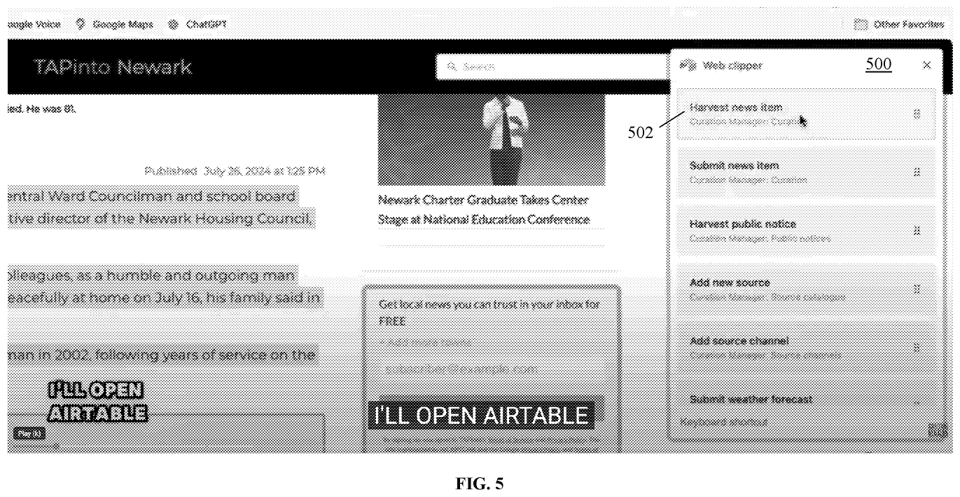

Referring now to FIG. 4, a flowchart of an exemplary method for automated digital content curation and distribution is illustrated. In some examples, key components of the method of the disclosed technology described in detail below include information gathering, human-in-the-loop editing, multi-platform publishing, and custom automation workflows. In step 400 in this example, the curation system 102 ingests digital content for news and event items from the editor device(s) 110. The ingested digital content can include metadata associated with the digital content. In one example, the digital content and/or metadata can be ingested using the harvesting application 124 communicably coupled to the web browser 122 of one of the editor device(s) 110. In this information gathering step, the harvesting application 124 can be used to collect and organize information from various sources such as Facebook pages, school district websites, and local news publishers, for example.

Referring to FIG. 5, a screenshot of an exemplary harvesting tool content ingestion interface 500 is illustrated. In this example, the web browser 122 has loaded a web page, a user of one of the editor device(s) 110 has selected text content included on that web page (e.g., a portion of a news article), and the user has engaged the harvesting application 124, which in this example is a web clipper web browser plug-in that is provided by Airtable and communicably coupled to the database application 120 that is also provided by Airtable, although other types of harvesting and/or database applications can be used in other examples. Accordingly, the user of one of the editor device(s) 110 engages the web clipper plug-in after selecting the text content and selects the harvest news item button 502 of the harvesting tool content ingestion interface 500.

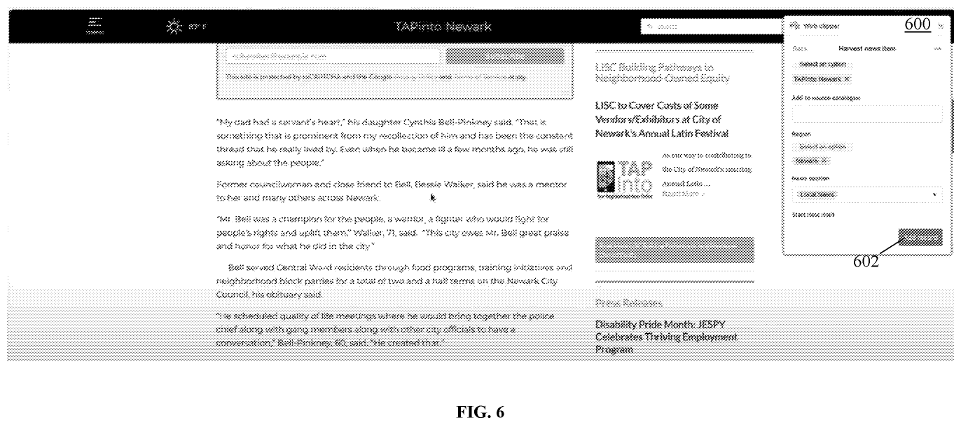

Referring to FIG. 6, a screenshot of an exemplary harvesting tool metadata ingestion interface 600 is illustrated. After selecting the harvest news item button 502 of the harvesting tool content ingestion interface 500, the web clipper plug-in in this example presents the harvesting tool metadata ingestion interface 600 to facilitate ingestion of metadata associated with the news item being harvested. The metadata can include a geographic region to which the digital content is associated, a section of a newsletter for the digital content, or a date upon which the news item should be published, for example. When finished, the user can select the add record button 602 of the harvesting tool metadata ingestion interface 600, which sends the digital content (e.g., the selected text) and metadata associated with the news item to the database application 120 for insertion as a news item record.

While the information gathering described herein with reference to FIGS. 5-6 is initiated by a human user of one of the editor device(s) 110, the ingestion of information can also be automated in other examples. More specifically, the curation system 102 can be configured to periodically poll particular web pages, extract content based on a set of rules, and/or analyze the web pages and/or extracted content based on another set of rules to generate associated metadata, for example. Other automated digital content and metadata ingestion can also be used in other examples.

Referring back to FIG. 4, in step 402, the curation system 102 classifies the content by automatically determining whether the content relates to an event or a news item. In some examples, the classification can be based on a parsing of the digital content (e.g., text) to determine whether an event date is identified therein, and, in other examples, the classification can be based on metadata input by a user or automatically generated that indicates a date of occurrence of an event. Absent an identified date, the item is classified as a news item and, if a date is identified, the item is classified as an event. Other methods for classifying the ingested digital content can also be used.

In step 404, the curation system 102 generates summaries and other contextual data (e.g., headlines) using AI. In one particular example, the summarization of step 404 uses an AI-assisted (e.g., ChatGPT) content processing workflow through the automated orchestration application 118 (e.g., Zapier) to summarize news articles and events, generate draft headlines, and check for duplicate content. Thus, Zapier can be configured to poll the database application 120 (e.g., Airtable) to determine whether a new record was created and execute automation software previously defined therein to apply the AI assistant or other machine learning model to the ingested digital content to generate summaries and other contextual data.

In step 406, the curation system 102 generates headlines for the event and/or news item. The headline can be generated in a similar manner to the summaries in step 404 in some examples. Thus, the headline generation can be initiated by a code module within the automated orchestration application 118 (e.g., as provided by Zapier) that leverages an AI assistant, for example.

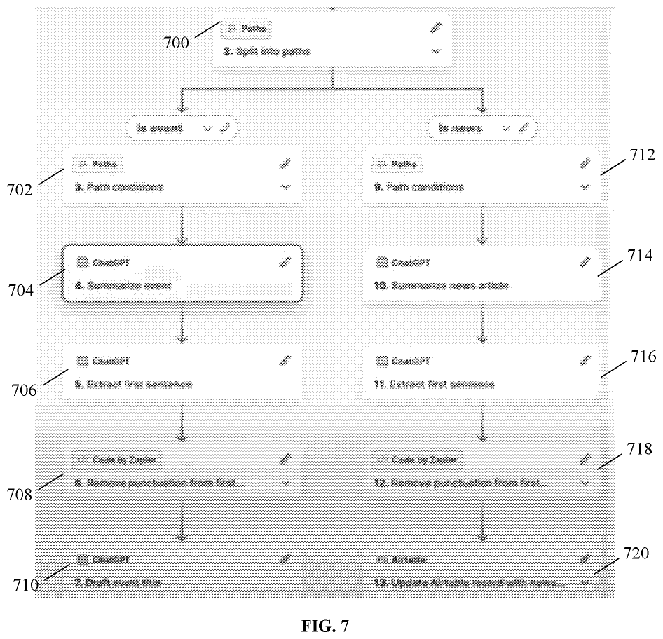

Referring to FIG. 7, a flowchart of an exemplary method for event and news item database population is illustrated. FIG. 7 illustrates exemplary steps for digital content and contextual data generation of steps 404-406. In step 700 in this example, the curation system 102 determines whether ingested digital content represents an event item or a news item (e.g., based on whether a date is recited therein). If the curation system 102 determines that the digital content represents an event, then the event branch is taken to step 702.

In step 702, the curation system 102 evaluates conditions associated with the ingested digital content to determine whether the content corresponds to an event item and to route the content to the appropriate processing path. The evaluation may include an analysis of one or more attributes of the specific content. When the criteria associated with an event-processing path are satisfied, the curation system 102 routes the content to the event-processing path for further processing.

In step 704, the curation system 102 processes the event-related content to generate one or more structured data elements for use in downstream applications. For example, the curation system 102 may generate a summary of the content, extract or identify relevant portions of the content, and normalize the extracted content for further processing.

In step 706, the curation system 102 extracts the first sentence of the selected text that was ingested with the digital content. In step 708, the curation system 102 removes punctuation from the first sentence. In step 710, the curation system 102 generates an event title based on the first sentence without punctuation, optionally using the same or a different trained AI or machine learning model. The event title or headline can then be stored in the corresponding record by the database application 120. The event title facilitates the categorization of an event compared to a news item.

However, if the curation system 102 determines in step 700 that the ingested digital content relates to a news item, then the news branch is taken to step 712. In step 712, the curation system 102 evaluates conditions associated with the ingested digital content to determine whether the content corresponds to a news item and to route the content to the appropriate processing path. The evaluation may include an analysis of one or more attributes of the specific content. When the criteria associated with a news-processing path are satisfied, the curation system 102 routes the content to the news-processing path for further processing.

In step 714, the curation system 102 processes the news-related content to generate one or more structured data elements for use in downstream applications. For example, the curation system 102 may generate a summary of the content, extract or identify relevant portions of the content, and normalize the extracted content for further processing.

In step 716, the curation system 102 extracts the first sentence of the selected text that was ingested with the digital content. In step 718, the curation system 102 removes punctuation from the first sentence. In step 720, the curation system 102 generates a new title or headline based on the first sentence without punctuation, optionally using the same or a different trained AI or machine learning model The headline can then be stored in the corresponding record by the database application 120.

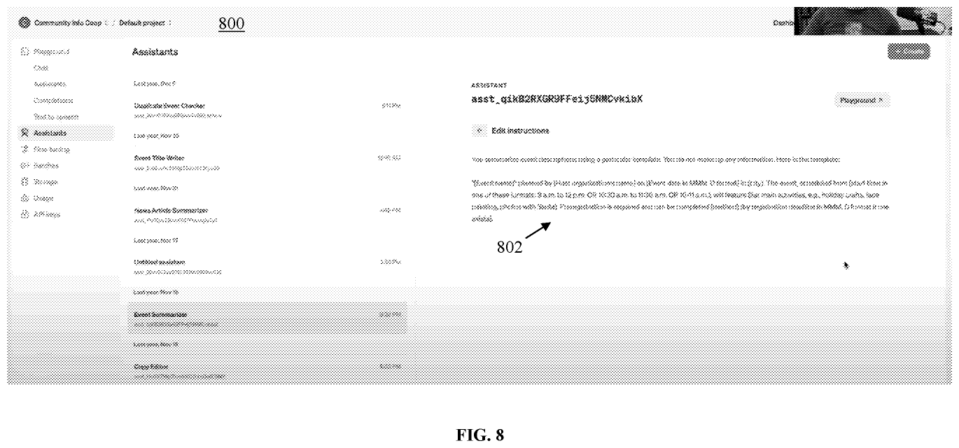

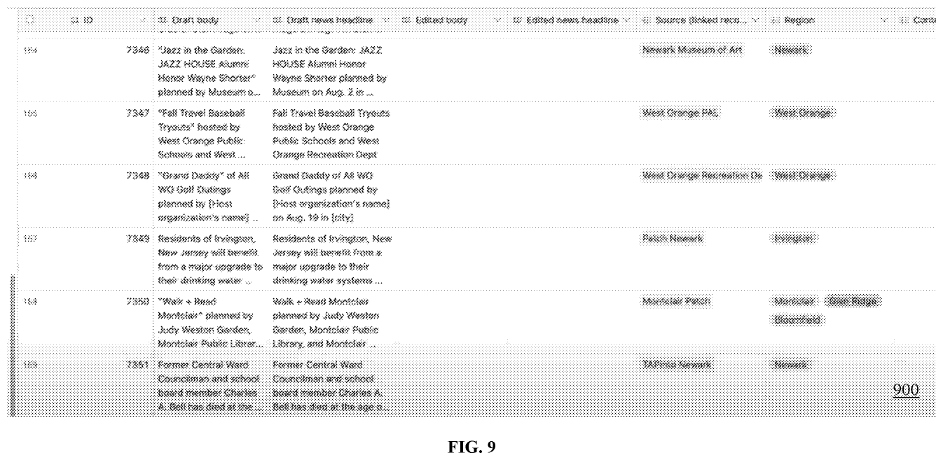

Referring to FIG. 8, a screenshot of an AI assistant dashboard 800 is illustrated. In this example, several AI assistants or trained AI or machine learning models are disclosed. Exemplary AI assistants leveraged by the disclosed technology include duplicate event checking, event title writing, and news article summarization, although any number of AI assistants can be used in other examples. In the exemplary AI assistant dashboard 800, an event summarizer AI assistant is selected in a left pane and an exemplary template prompt 802 for the selected event summarizer AI assistant is illustrated in a right pane. Other types of formats, templates, or prompts for generating event summaries can also be used in other examples.

Referring back to FIG. 4, in step 408, the curation system 102 detects duplicate items. In some examples, deduplication is performed only for event items and, in other examples, deduplication can be performed for both event and news items. Optionally, the deduplication can be performed by a trained AI or machine learning model (e.g., one of the AI assistants illustrated in FIG. 8). Duplication can occur when multiple editor users of the editor device(s) 110 cause the curation system 102 to ingest digital content associated with the same event and/or news item, for example. The deduplication can be initiated by a code module within the automated orchestration application 118 (e.g., as provided by Zapier).

Referring to FIG. 9, a screenshot of a content item database interface 900 from the perspective of news items is illustrated. The content item database interface 900 illustrates exemplary records maintained in a database, table, or other data structure by the database application 120 after the ingestion of the digital content and metadata and generation by AI assistant(s) of a body and headline for exemplary news items, among other contextual data that can be generated in other examples. Accordingly, each of the news items illustrated in FIG. 9 is associated with a generated identifier (ID), a draft body generated by an AI assistant, a draft news headline generated by an AI assistant, a source ingested via metadata for the news item, and a region that is also ingested via metadata for the news item, although other information can also be ingested, generated, and/or stored for news items in other examples.

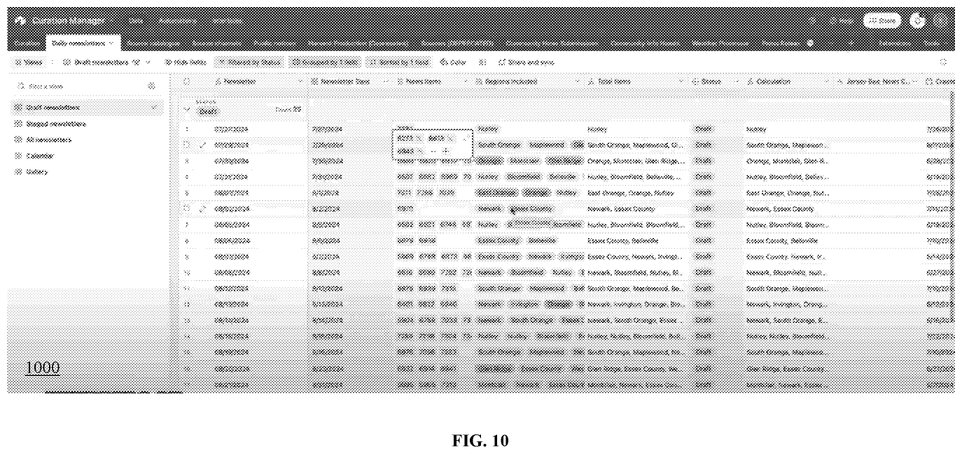

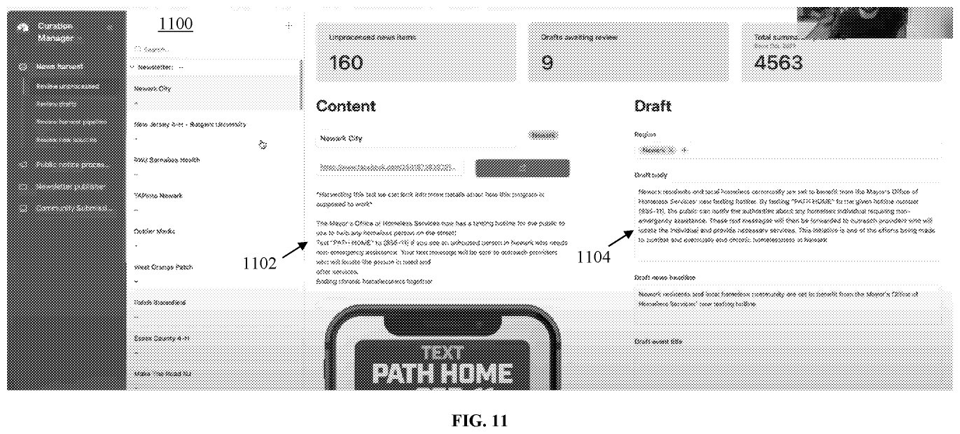

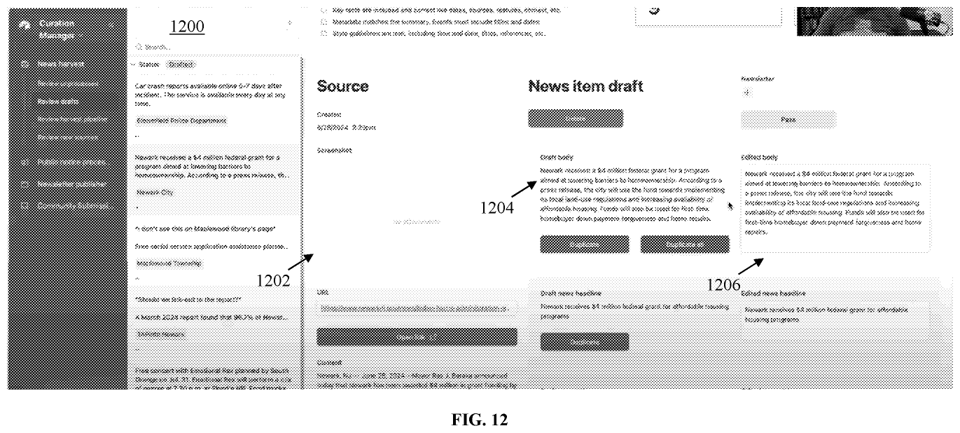

Referring to FIG. 10, a screenshot of a content item database interface 1000 from the perspective of a newsletter is illustrated. In this example, a newsletter is composed of a plurality of news items associated with particular geographies, based on news item tags or metadata, and is configured to be distributed periodically (e.g., daily) via web pages, social media, and/or e-mail format, for example, as explained in more detail below. The content item database interface 1000 in this example is a GUI generated by the database application 120 based on database contents (e.g., as illustrated in FIG. 9). Each newsletter is associated in the content item database interface 1000 with IDs for news items that are to be distributed as part of the newsletter. Additional database fields illustrated via columns in FIG. 10 include the geographies associated with the newsletter and the status (i.e., “draft” for newsletters for which editing has not been completed and the newsletter has not been stages), although other information can also be included on the content item database interface 1000 in other examples.

Referring back to FIG. 4, in step 410, which can be a human-in-the-loop editing step, the curation system 102 facilitates review, editing, and content refinement for the digital content ingested and/or generated for the news and/or event items in steps 400-408. In the human-in-the-loop editing step, editors can use an Airtable interface to review and refine AI-generated summaries and headlines, categorize the content, and ensure each news item is assigned to the appropriate newsletter(s).

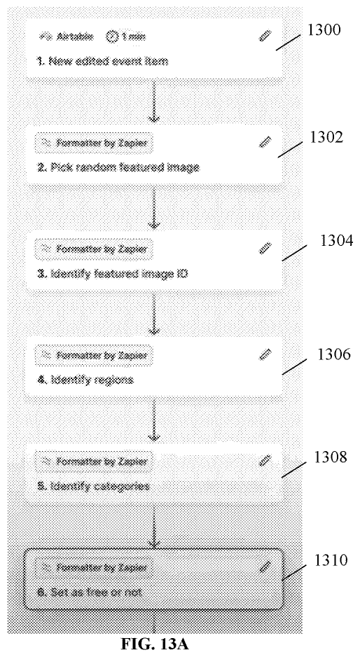

Referring to FIG. 11, a screenshot of an exemplary item initial review interface 1100 is illustrated. The item initial review interface 1100 can be generated by the database application 120 (e.g., provided by Airtable) and can include at least a portion of the original ingested content 1102 displayed proximate draft content 1104, such as metadata or contextual data (e.g., a geographic region) and a body, news headline, or event title generated by one or more AI assistants. The item initial review interface 1100 can be provided upon request to one of the editor device(s) 110 and can be used to revise the draft body, news headline, or event title, for example. The utilization of the AI assistants results in a more efficient news and event item preparation or generation process.

Referring to FIG. 12, a screenshot of an exemplary item final review interface 1200 is illustrated. In this example, another editor using one of the editor device(s) 110 can review the original ingested content 1202 proximate the draft content 1204 and the edited content 1206 resulting from the submission of the edited news or event item via the item initial review interface 1100 to thereby provide a quality assurance review. Optionally, in this subsequent editing step, the editor can duplicate the draft content 1204 into the edited content 1206 to make editing more efficient and delete and/or pass on a news item that the editor does not believe should be incorporated into a current newsletter. Upon submission of the item data via the item initial review interface 1100 and the item final review interface 1200, the item data is stored in the database maintained by the database application 120.

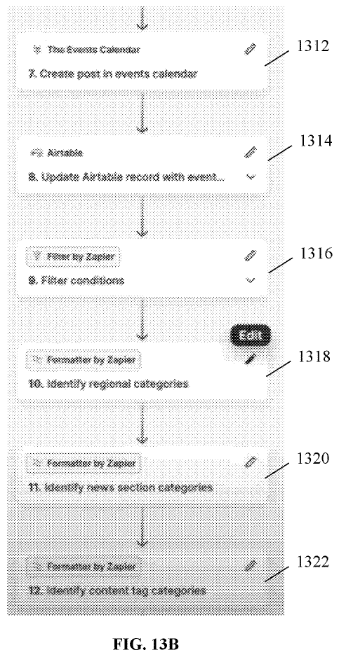

Referring back to FIG. 4, in step 412, the curation system 102 assigns news and event items to categories and particular newsletters (e.g., newsletter dates for particular geographies). Referring to FIGS. 13A-B, flowcharts of an exemplary method for event item database population are illustrated with a similar process performable for news item database population. In step 1300 in this example, the curation system 102 identifies a new edited event item, such as may have been submitted via the item final review interface 1200 from FIG. 12 and stored in the database maintained by the database application 120.

In step 1302, the curation system 102 selects a random featured image, such as based on a code module of the automated orchestration application 118 (e.g., as provided by Zapier) executed against or applying rules to the original ingested content. For example, the automated orchestration application 118 can be configured to extract an image from a webpage using a URL for the webpage included in the original ingested content and one or more rules applied to the content of the webpage. The selected featured image can be appended to the database record for the event item.

In step 1304, the curation system 102 identifies a featured image ID for the image to be posted for a web post or event calendar event and selected in step 1302. The selection may be based on one or more attributes of the ingested content.

In step 1306, the curation system 102 identifies one or more geographic regions associated with the event item. The regions can be identified by the automated orchestration application 118 applying rules to the original ingested content and/or or the reviewed and/or edited event item content to thereby parse that content and identify a geography and adjacent geographies, for example. In other examples, the regions can be included as metadata with the original ingested content. The result of the identification of geographic regions can be appended to the database record for the event item.

In step 1308, the curation system 102 identifies categories for the event item again based on an execution of the automated orchestration application 118 against the original ingested content and/or or the reviewed and/or edited event item content. The categories can relate to a type of event (e.g., sporting event or musical event), for example. The result of the identification of categories can be appended to the database record for the event item.

In step 1310, the curation system 102 executing the automated orchestration application 118 determines whether the event associated with the event item is free or has an associated cost (e.g., admission cost). The result of the determination can be appended to the database record for the event item.

In step 1312, the curation system 102 creates a post in an events calendar. In step 1314, the curation system 102 updates the event item record in the database managed by the database application 120. The record can be updated to reflect the post (e.g., the date identified for the event item). In step 1316, the curation system 102 generates filter conditions for the post and, in steps 1318 and 1320, the curation system 102 identifies regional and new section categories for the post, respectively. Finally, in step 1322, the curation system 102 identifies content tag categories for the post.

Referring back to FIG. 4, in step 414, the curation system 102 publishes the event or news item, such as to a website, calendar, and/or social media network. The website, calendar, and/or social media network can be hosted by the web server 114 and/or the third-party publishing destination(s) 108, for example. The publishing can be based on the contents of the event and/or news item record stored in the database maintained by the database application 120 and can use an API provided by a host of the website, calendar, and/or social media network, for example. Optionally, templates can be provided by other cloud applications (e.g., as provided by WordPress) of the curation system 102 and used by the automated orchestration application 118 to facilitate and format the news or event item publishing.

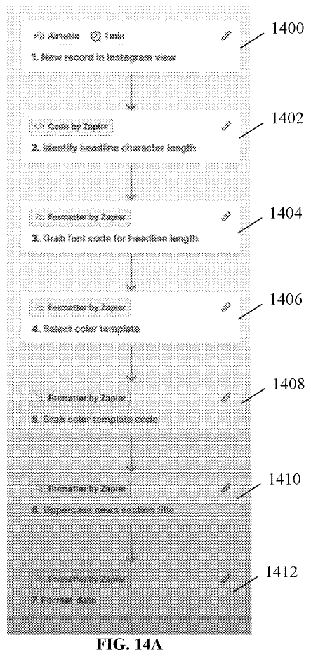

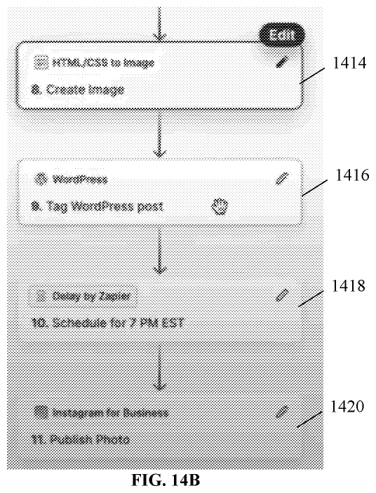

Referring to FIGS. 14A-B, a method for generating and distributing a formatted visual representation of processed content is illustrated. Specifically, flowcharts of an exemplary method for third-party social media newsletter publication are illustrated. The method enables automated generation and distribution of visually formatted content, thereby improving consistency and efficiency in multiple social-media platform content publishing. In step 1400 in this example, the curation system 102 determines that a new news item record in this example has been identified for social media network posting, which in this example is Instagram™.

In step 1402, the curation system 102 executing the automated orchestration application 118 identifies a headline character length. In step 1404, the curation system 102 executing the automated orchestration application 118 identifies a font code for the headline length. In step 1406, the curation system 102 executing the automated orchestration application 118 selects a color template. In step 1408, the curation system 102 executing the automated orchestration application 118 collects a color template code for the color template. In step 1410, the curation system 102 executing the automated orchestration application 118 formats the news item title. In step 1412, the curation system 102 executing the automated orchestration application 118 formats a date associated with the news item.

In step 1414, the curation system 102 generates a web page HTML/CSS and captures the result as an image. In step 1416, the curation system 102 tags a WordPress post based on geographies and content categories, optionally determined by a trained AI or machine learning model. In step 1418, the curation system 102 executing the automated orchestration application 118 schedules the post for deployment as a specified time. In step 1420, the curation system 102 publishes the photo or image generated in step 1414 based on the schedule generated in step 1418.

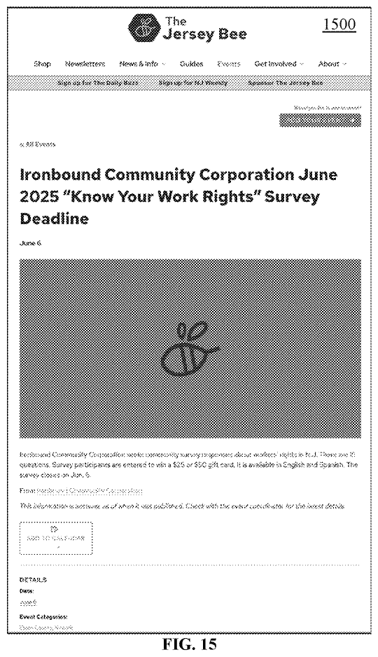

Referring to FIG. 15, a screenshot of an exemplary event publication 1500 on a website is illustrated. The event publication includes a headline, featured image, and summary description along with event details (e.g., date and category) and an option to add to a local calendar for a user of one of the viewer device(s) 112. Accordingly, in the multi-platform publishing step of FIG. 14, once each item is drafted, reviewed, categorized, and staged, the curation system 203 uses an automated publishing workflow to create email newsletters (via Mailchimp™), website updates (WordPress); social media network posts (e.g., with auto-generated image cards), and/or events calendar items. In a custom automation workflow step, Zapier can be used to connect various tools and automated processes. Custom code modules are then used to automate specific tasks, such as formatting dates and selecting random colors, for example.

In step 416 of FIG. 4, the curation system 102 creates a geographic or topical newsletter that gathers any number of news items linked or tagged to the newsletter in the database maintained by the database application 120.

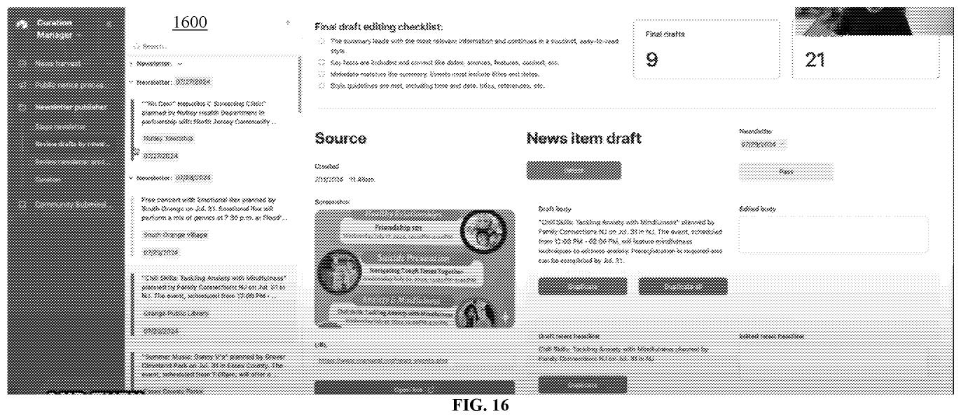

In step 418 of FIG. 4, the curation system 102 facilitates a final review before newsletter distribution. Referring to FIG. 16, a screenshot of an exemplary newsletter final review interface 1600 is illustrated. In this example, the newsletter final review interface 1600 can be a GUI generated by the database application 120 and provided to one of the editor device(s) 110, for example. The newsletter final review interface 1600 includes a list of newsletters organized by date in a left-most pane that includes selectable news items associated with each newsletter organized by color indicating whether the news items have been initially or finally reviewed and edited. Selecting one of the news items causes the newsletter final review interface 1600 to retrieve and display on the newsletter final review interface 1600 original ingested content and generated draft and/or edited content retrieved from the corresponding record for the news item in the database maintained by the database application 120.

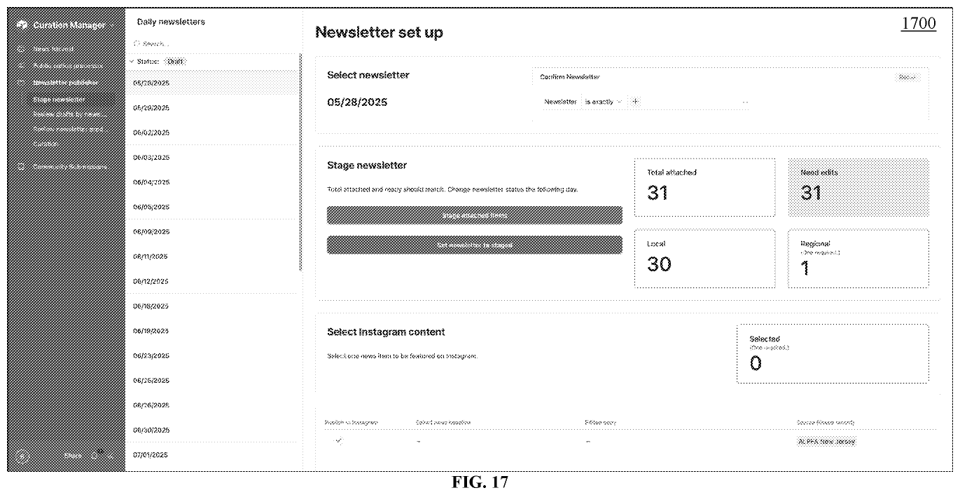

In step 420, the curation system 102 automatically distributes a finalized newsletter based on an established staging schedule. Referring to FIG. 17, a screenshot of an exemplary newsletter orchestration interface 1700 is illustrated. The newsletter orchestration interface 1700 can be a GUI generated by the database application 120 and provided to one of the editor device(s) 110, for example. The newsletter orchestration interface 1700 allows an editor to determine contextual information relating to the newsletter (e.g., how many news items are attached or still require editing and/or the regions associated with the newsletter) and facilitates staging of a newsletter with respect to the timing of distribution (e.g., website posting).

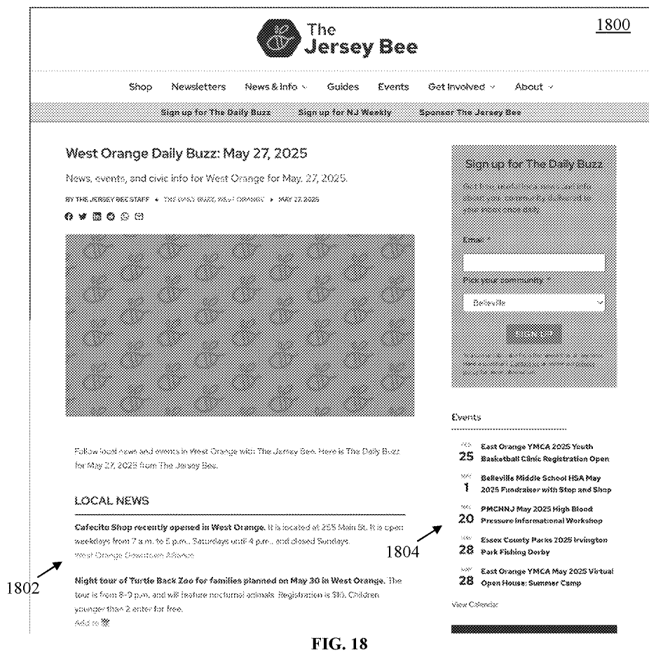

Referring to FIG. 18, a screenshot of an exemplary newsletter publication 1800 is illustrated. The newsletter publication 1800 in this example includes news items 1802 and event items 1804 linked to the newsletter (i.e., the May 27, 2025, newsletter in this example) and the region for the newsletter (i.e., West Orange in this example) in their respective records in the database maintained by the database application 120. The news items 1802 are displayed based on their headline and summary in this example. The event items 1804 are displayed based on their titles and corresponding date.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A curation system, comprising memory having instructions stored thereon for automated digital content curation and distribution and one or more processors configured to execute the instructions to:
ingest, to a record of a database of the curation system, unstructured digital content and associated metadata from an editor device via one or more communication networks, wherein the unstructured digital content is hosted by a content source device coupled to the communication networks and is obtained via a harvesting application that is executed by the editor device and is communicably coupled to the database;
determine whether the unstructured digital content corresponds to a news item or an event item based on an analysis of the unstructured digital content or the metadata to determine whether a date is identified therein, wherein the metadata is obtained via a graphical user interface generated and output to the editor device by the harvesting application;
apply a stored and trained machine learning model to the unstructured digital content and the metadata to generate and store in the record structured contextual data comprising a summary and a headline, when the determination indicates the unstructured digital content corresponds to the news item, and a title, when the determination indicates the unstructured digital content corresponds to the event item, after determining via polling of the database by an automated orchestration application that the record was created;
link the record to a newsletter in the database based at least in part on a geographic region determined via parsing, by the automated orchestration application, one or more of the unstructured digital content or the metadata, wherein the record is linked to the newsletter in the database based on a generated unique identifier for the newsletter; and
upon satisfaction of staging criteria, publish the newsletter via a first webpage hosted by a web server of the curation system based on contents of the record, wherein the published newsletter comprises the date and the title or the news headline and the summary.

2. The curation system of claim 1, wherein the one or more processors are further configured to execute the instructions to apply one or more artificial intelligence assistants within the automated orchestration application to at least one of the unstructured digital content or the metadata to perform one or more of duplicate item checking, event title writing, news article headline writing, or news article summarization.

3. The curation system of claim 1, wherein the one or more processors are further configured to execute the instructions to:
obtain a featured image for the event item using a uniform resource locator in the metadata for a webpage associated with the unstructured digital content;
store the featured image in the record; and
publish from the record the featured image for the event item via a second webpage hosted by the web server and hyperlinked to one or more of the date or the title.

4. The curation system of claim 1, wherein the one or more processors are further configured to execute the instructions to:
generate post characteristics comprising one or more of a headline length, a font code, a color template, or a date format and, based on the post characteristics and one or more of the unstructured digital content or the metadata, a snippet comprising webpage source code; and
publish, via an application programming interface for a social media platform, a social media post comprising an image generated based on a rendering of the snippet according to the webpage source code.

5. The curation system of claim 1, wherein the one or more processors are further configured to execute the instructions to generate, and provide to the editor device, an item initial review interface comprising at least a portion of the unstructured digital content or the metadata and editable fields for a body and the headline or the title, wherein the body is generated from the unstructured digital content by an artificial intelligence assistant within the automated orchestration application.

6. The curation system of claim 1, wherein the one or more processors are further configured to execute the instructions to:
generate, and provide to the editor device, a newsletter orchestration interface comprising newsletter context data generated from the database based on the unique identifier for the newsletter; and
obtain, and store in the database, the staging criteria via the newsletter orchestration interface, wherein the staging criteria comprises at least a timing of distribution of the newsletter.

7. A method for automated digital content curation and distribution, the method implemented by one or more curation systems and comprising:
ingesting, to a record of a database of the curation system, unstructured digital content and associated metadata from an editor device via one or more communication networks, wherein the unstructured digital content is hosted by a content source device coupled to the communication networks and is obtained via a harvesting application that is executed by the editor device and is communicably coupled to the database;
determining whether the unstructured digital content corresponds to a news item or an event item based on an analysis of the unstructured digital content or the metadata to determine whether a date is identified therein, wherein the metadata is obtained via a graphical user interface generated and output to the editor device by the harvesting application;
applying a stored and trained machine learning model to the unstructured digital content and the metadata to generate and store in the record structured contextual data comprising a summary and a headline, when the determination indicates the unstructured digital content corresponds to the news item, and a title, when the determination indicates the unstructured digital content corresponds to the event item, after determining via polling of the database by an automated orchestration application that the record was created;
linking the record to a newsletter in the database based at least in part on a geographic region determined via parsing, by the automated orchestration application, one or more of the unstructured digital content or the metadata, wherein the record is linked to the newsletter in the database based on a generated unique identifier for the newsletter; and
upon satisfaction of staging criteria, publishing the newsletter via a first webpage hosted by a web server of the curation system based on contents of the record, wherein the published newsletter comprises the date and the title or the news headline and the summary.

8. The method of claim 7, further comprising applying one or more artificial intelligence assistants within the automated orchestration application to at least one of the unstructured digital content or the metadata to perform one or more of duplicate item checking, event title writing, news article headline writing, or news article summarization.

9. The method of claim 7, further comprising:
obtaining a featured image for the event item using a uniform resource locator in the metadata for a webpage associated with the unstructured digital content;
storing the featured image in the record; and
publishing from the record the featured image for the event item via a second webpage hosted by the web server and hyperlinked to one or more of the date or the title.

10. The method of claim 7, further comprising:
generating post characteristics comprising one or more of a headline length, a font code, a color template, or a date format and, based on the post characteristics and one or more of the unstructured digital content or the metadata, a snippet comprising webpage source code; and
publishing, via an application programming interface for a social media platform, a social media post comprising an image generated based on a rendering of the snippet according to the webpage source code.

11. The method of claim 7, further comprising generating, and providing to the editor device, an item initial review interface comprising at least a portion of the unstructured digital content or the metadata and editable fields for a body and the headline or the title, wherein the body is generated from the unstructured digital content by an artificial intelligence assistant within the automated orchestration application.

12. The method of claim 7, further comprising:
generating, and providing to the editor device, a newsletter orchestration interface comprising newsletter context data generated from the database based on the unique identifier for the newsletter; and
obtaining, and storing in the database, the staging criteria via the newsletter orchestration interface, wherein the staging criteria comprises at least a timing of distribution of the newsletter.

13. One or more non-transitory computer readable media having stored thereon instructions comprising executable code that, when executed by one or more processors, causes the one or more processors to:
ingest, to a record of a database of the curation system, unstructured digital content and associated metadata from an editor device via one or more communication networks, wherein the unstructured digital content is hosted by a content source device coupled to the communication networks and is obtained via a harvesting application that is executed by the editor device and is communicably coupled to the database;
determine whether the unstructured digital content corresponds to a news item or an event item based on an analysis of the unstructured digital content or the metadata to determine whether a date is identified therein, wherein the metadata is obtained via a graphical user interface generated and output to the editor device by the harvesting application;
apply a stored and trained machine learning model to the unstructured digital content and the metadata to generate and store in the record structured contextual data comprising a summary and a headline, when the determination indicates the unstructured digital content corresponds to the news item, and a title, when the determination indicates the unstructured digital content corresponds to the event item, after determining via polling of the database by an automated orchestration application that the record was created;
link the record to a newsletter in the database based at least in part on a geographic region determined via parsing, by the automated orchestration application, one or more of the unstructured digital content or the metadata, wherein the record is linked to the newsletter in the database based on a generated unique identifier for the newsletter; and
upon satisfaction of staging criteria, publish the newsletter via a first webpage hosted by a web server of the curation system based on contents of the record, wherein the published newsletter comprises the date and the title or the news headline and the summary.

14. The one or more non-transitory computer-readable media of claim 13, wherein the instructions, when executed by the one or more processors further cause the one or more processors to apply one or more artificial intelligence assistants within the automated orchestration application to at least one of the unstructured digital content or the metadata to perform one or more of duplicate item checking, event title writing, news article headline writing, or news article summarization.

15. The one or more non-transitory computer-readable media of claim 13, wherein the instructions, when executed by the one or more processors further cause the one or more processors to:
obtain a featured image for the event item using a uniform resource locator in the metadata for a webpage associated with the unstructured digital content;
store the featured image in the record; and
publish from the record the featured image for the event item via a second webpage hosted by the web server and hyperlinked to one or more of the date or the title.

16. The one or more non-transitory computer-readable media of claim 13, wherein the instructions, when executed by the one or more processors further cause the one or more processors to:
generate post characteristics comprising one or more of a headline length, a font code, a color template, or a date format and, based on the post characteristics and one or more of the unstructured digital content or the metadata, a snippet comprising webpage source code; and
publish, via an application programming interface for a social media platform, a social media post comprising an image generated based on a rendering of the snippet according to the webpage source code.

17. The one or more non-transitory computer-readable media of claim 13, wherein the instructions, when executed by the one or more processors further cause the one or more processors to generate, and provide to the editor device, an item initial review interface comprising at least a portion of the unstructured digital content or the metadata and editable fields for a body and the headline or the title, wherein the body is generated from the unstructured digital content by an artificial intelligence assistant within the automated orchestration application.

18. The one or more non-transitory computer-readable media of claim 13, wherein the instructions, when executed by the one or more processors further cause the one or more processors to:
generate, and provide to the editor device, a newsletter orchestration interface comprising newsletter context data generated from the database based on the unique identifier for the newsletter; and
obtain, and store in the database, the staging criteria via the newsletter orchestration interface, wherein the staging criteria comprises at least a timing of distribution of the newsletter.
